(19) United States
(12) Patent Application Publication
(10) Pub. No.: US 2025/0361861 A1
(43) Pub. Date: Nov. 27, 2025

(54) VALVE CARTRIDGE FOR A FLUID PUMP

(71) Applicant: SPM Oil & Gas Inc., Fort Worth, TX (US)

(72) Inventors: Justin POEHLS, Glen Rose, TX (US); David T. FIGGS, Fort Worth, TX (US); Daryl BELSHAN, Weatherford, TX (US); Abraham CANALES, Crowley, TX (US); Nuder SAID, Fort Worth, TX (US); Chiawei Steven SU, Arlington, TX (US); Alireza ATABAIE, Keller, TX (US)

(73) Assignee: SPM Oil & Gas Inc., Fort Worth, TX (US)

(21) Appl. No.: 18/673,992

(22) Filed: May 24, 2024

(51) Int. Cl. F04B 49/22; F04B 53/14; F16K 15/06

(52) U.S. Cl. CPC F04B 49/22; F16K 15/066; F04B 53/22; F16K 2200/501

(57) ABSTRACT

A valve cartridge for a fluid pump may include a cartridge body, a fluid cavity defined in the cartridge body, one or more suction passageways, defined through the cartridge body, that open into the fluid cavity, and a suction valve assembly configured to control flow from the one or more suction passageways into the fluid cavity. The suction valve assembly may include an annular valve having a central opening, a perimeter edge, and a sealing surface defined between the central opening and the perimeter edge, and a biasing element configured to bias the annular valve to a closed position. In an open position, the annular valve may allow flow from the suction passageway(s) into the fluid cavity. In the closed position, the annular valve may seal the suction passageway(s) from the fluid cavity, and allow flow through the fluid cavity via the central opening.

### TECHNICAL FIELD

The present disclosure relates generally to fluid pumps and, for example, to a valve cartridge for a fluid pump.

### BACKGROUND

Hydraulic fracturing is a well stimulation technique that typically involves pumping hydraulic fracturing fluid into a wellbore at a rate and a pressure (e.g., up to 15,000 pounds per square inch (psi)) sufficient to form fractures in a rock formation surrounding the wellbore. This well stimulation technique often enhances the natural fracturing of a rock formation to increase the permeability of the rock formation, thereby improving recovery of water, oil, natural gas, and/or other fluids.

A hydraulic fracturing system may employ one or more fluid pumps for pressurizing hydraulic fracturing fluid. A fluid pump has a suction side, at which low-pressure fluid enters the fluid pump via a suction valve assembly to be pressurized, and a discharge side at which high-pressure fluid pressurized by the fluid pump exits the fluid pump via a discharge valve assembly. A valve assembly may include various components, such as a valve, a valve seat, a spring, a spring retainer, or the like. Each of these components is subject to wear and/or failure, and therefore may be serviced (e.g., reconditioned, repaired, or replaced) from time to time (e.g., about every 100 hours). For example, for servicing, the suction and discharge valve assemblies of the fluid pump may be disassembled and removed from the fluid pump, sometimes using specialized equipment, and then reassembled in the fluid pump following servicing. Accordingly, servicing the suction and discharge valve assemblies of the fluid pump is time consuming and inefficient.

The valve cartridge of the present disclosure solves one or more of the problems set forth above and/or other problems in the art.

### SUMMARY

A valve cartridge for a fluid pump may include a cartridge body having a first end and a second end opposite the first end, a fluid cavity defined in the cartridge body, one or more suction passageways, defined through the cartridge body, that open into the fluid cavity, and a suction valve assembly configured to control flow from the one or more suction passageways into the fluid cavity. The suction valve assembly may include an annular valve having a central opening, a perimeter edge, and a sealing surface defined between the central opening and the perimeter edge, and a biasing element configured to bias the annular valve to a closed position. In an open position, the annular valve is to allow flow from the one or more suction passageways into the fluid cavity. In the closed position, the annular valve is to seal the one or more suction passageways from the fluid cavity, and to allow flow through the fluid cavity via the central opening.

A check valve assembly may include an annular valve having a central opening, a perimeter edge, and a sealing surface defined between the central opening and the perimeter edge. The check valve assembly may include a first sealing insert embedded in the annular valve nearer to the central opening than to the perimeter edge. The check valve assembly may include a second sealing insert embedded in the annular valve nearer to the perimeter edge than to the central opening.

A fluid pump may include a fluid end having a fluid end block with a bore, and a plunger configured to reciprocate with respect to the bore. The fluid pump may include a power end operably connected to the plunger. The fluid pump may include a valve cartridge, configured for insertion into and removal from the bore as a unit. The valve cartridge may include a cartridge body having a first end and a second end opposite the first end, a fluid cavity defined in the cartridge body, one or more passageways, defined through the cartridge body, that open into the fluid cavity, and a valve assembly configured to control flow between the one or more passageways and the fluid cavity. The valve assembly may include an annular valve having a central opening, a perimeter edge, and a sealing surface defined between the central opening and the perimeter edge, and a biasing element configured to bias the annular valve to a closed position.

### BRIEF DESCRIPTION OF THE DRAWINGS

FIG. 1 is a sectional view of an example fluid pump.

FIG. 2 is a sectional view of an example of a fluid end of a fluid pump.

FIG. 3 is a perspective view of an example check valve assembly.

FIGS. 4-5 are cross-sectional views of an example valve cartridge.

### DETAILED DESCRIPTION

This disclosure relates to a valve cartridge, which is applicable to any positive displacement fluid pump.

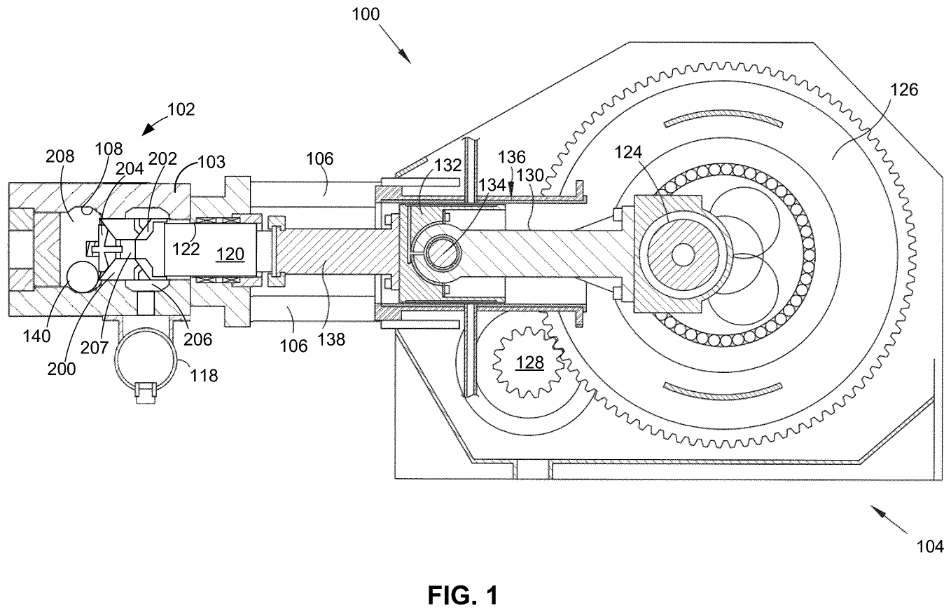

FIG. 1 is a sectional view of an example fluid pump 100. The fluid pump 100 includes a fluid end 102 and a power end 104. The fluid end 102 may be connected to the power end 104 by stay rods 106. The fluid end 102 includes a fluid end block 103 having one or more bores 108 (only one shown). For example, the fluid pump 100 may include one, two, three, four, five, or more bores 108. In some implementations, the fluid pump 100 may be mounted on a trailer to facilitate transportation of the fluid pump 100 between operational sites. In some implementations, the fluid pump 100 may be a hydraulic fracturing pump. For example, the fluid pump 100 may have a capability to produce a discharge pressure of at least 8,000 psi, at least 10,000 psi, at least 12,000 psi, or at least 15,000 psi.

The bore 108 is a passageway through the fluid end block 103 of the fluid end 102. The fluid end 102 may include a valve cartridge 200 disposed in the bore 108 (e.g., a respective valve cartridge 200 may be disposed in each bore 108 of the fluid end 102). For example, the valve cartridge 200 is configured for insertion into, and removal from, the bore 108 as a unit. The valve cartridge 200 includes a suction valve assembly 202 and a discharge valve assembly 204. The bore 108 may be contoured such that when the valve cartridge 200 is disposed in the bore 108, the valve cartridge 200 partitions the bore 108 into a suction chamber 206, a pressure chamber 207, and a discharge chamber 208 of the bore 108. For example, the suction chamber 206 of the bore 108 may be fluidly connected to a suction manifold 118, and the discharge chamber 208 of the bore 108 may be fluidly connected to a discharge manifold 140.

In operation, fluid is pressurized to a low pressure (e.g., 80 psi) by an outside system (e.g., a centrifugal pump) and pushed through the suction manifold 118 through the suction valve assembly 202 and into the pressure chamber 207. The fluid is then pumped in response to a forward stroke of a plunger 120 and flows through the discharge valve assembly 204.

In operation, the plunger 120 moves in a plunger bore 122 and is driven by the power end 104 of the fluid pump 100. The power end 104 includes a crankshaft 124 that is rotated by a gearbox output 126, which is illustrated by a single gear but may be more than one gear. A gearbox input 128 is coupled to a transmission (not shown) and/or a prime mover (not shown), such as a diesel engine, to rotate the gearbox input 128 during operation. A connecting rod 130 mechanically connects the crankshaft 124 to a crosshead 132 via a wrist pin 134. The crosshead 132 is mounted within a stationary crosshead housing 136, which constrains the crosshead 132 to linear reciprocating movement. A pony rod 138 connects to the crosshead 132 and has its opposite end connected to the plunger 120 to enable reciprocating movement of the plunger 120.

In operation, movement of the crankshaft 124 causes the plunger 120 to reciprocate with respect to the bore 108 (e.g., to reciprocate toward and away from the bore 108). As the plunger 120 translates away from the bore 108 (a suction stroke of the plunger 120), the pressure of the fluid inside the pressure chamber 207 decreases, which creates a pressure differential across the suction valve assembly 202. The pressure differential across the suction valve assembly 202 enables actuation of a valve of the suction valve assembly 202 to allow the fluid to enter the pressure chamber 207 from the suction manifold 118 (e.g., the valve may open responsive to the pressure differential). The pumped fluid is pushed into the pressure chamber 207 as the plunger 120 continues to translate away from the bore 108. As the plunger 120 changes directions and moves toward the bore 108 (a discharge stroke of the plunger 120), the fluid pressure inside the pressure chamber 207 increases, which creates a pressure differential across the discharge valve assembly 204. Fluid pressure inside the pressure chamber 207 continues to increase as the plunger 120 approaches the bore 108 until the pressure differential across the discharge valve assembly 204 is great enough to actuate a valve of the discharge valve assembly 204 and enable the fluid to exit the pressure chamber 207 (e.g., the valve may open responsive to the pressure differential).

As indicated above, FIG. 1 is provided as an example. Other examples may differ from what is described with regard to FIG. 1.

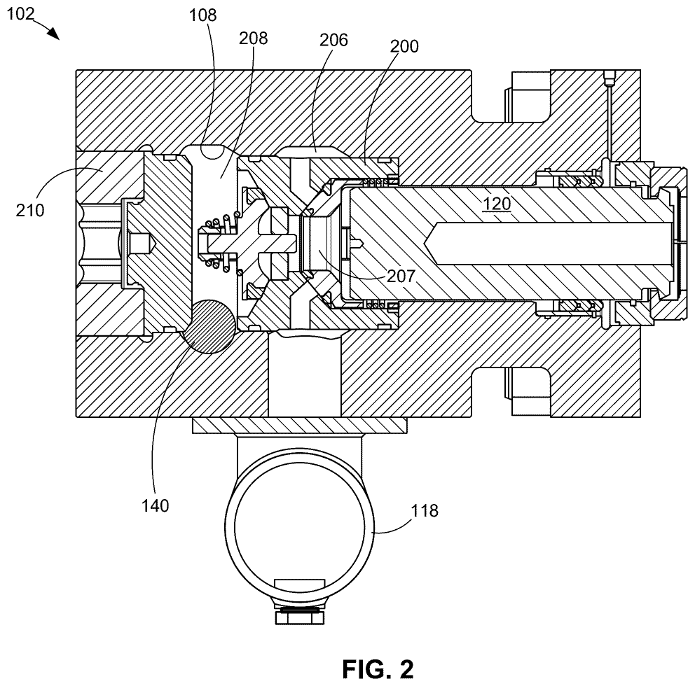

FIG. 2 is a sectional view of an example of the fluid end 102 of the fluid pump 100. The example fluid end 102 of FIG. 2 may include the valve cartridge 200 that is removably disposed in the bore 108. The valve cartridge 200 may be arranged in the bore 108 co-axially with the plunger 120.

In some examples, the fluid end 102 may include an end cap assembly 210 disposed in the bore 108. The end cap assembly 210 may seal an end of the bore 108. The end cap assembly 210 may be removed from the bore 108 to provide access to the valve cartridge 200. Thus, with the end cap assembly 210 removed from the bore 108, the valve cartridge 200 may be removed from the fluid end 102, as a unit (e.g., components of the suction valve assembly 202 and of the discharge valve assembly 204 are removed together as a unit), to facilitate repair or replacement of the valve cartridge 200. Similarly, a replacement, or a repaired, valve cartridge 200 may be inserted into the bore 108 and the end cap assembly 210 may be replaced back into the bore 108 to reseal the bore 108.

As indicated above, FIG. 2 is provided as an example. Other examples may differ from what is described with regard to FIG. 2.

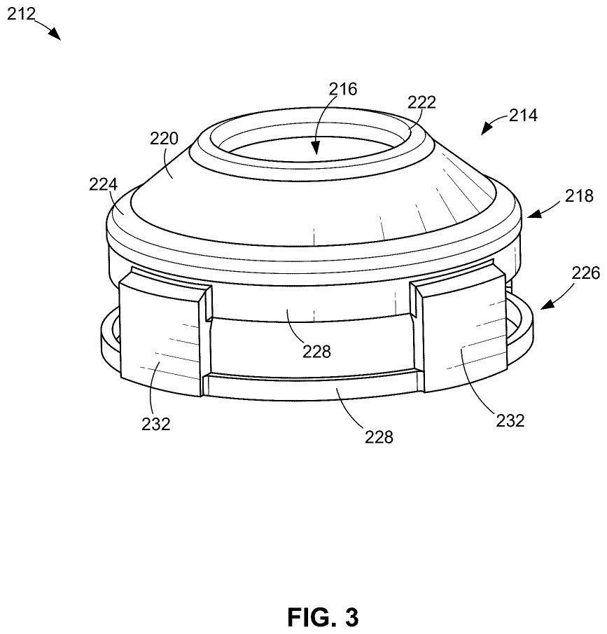

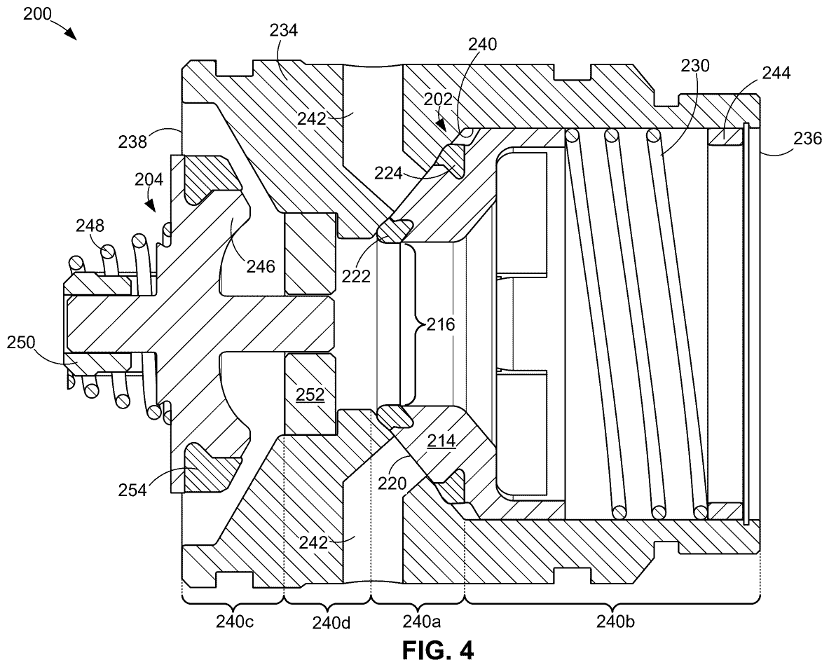

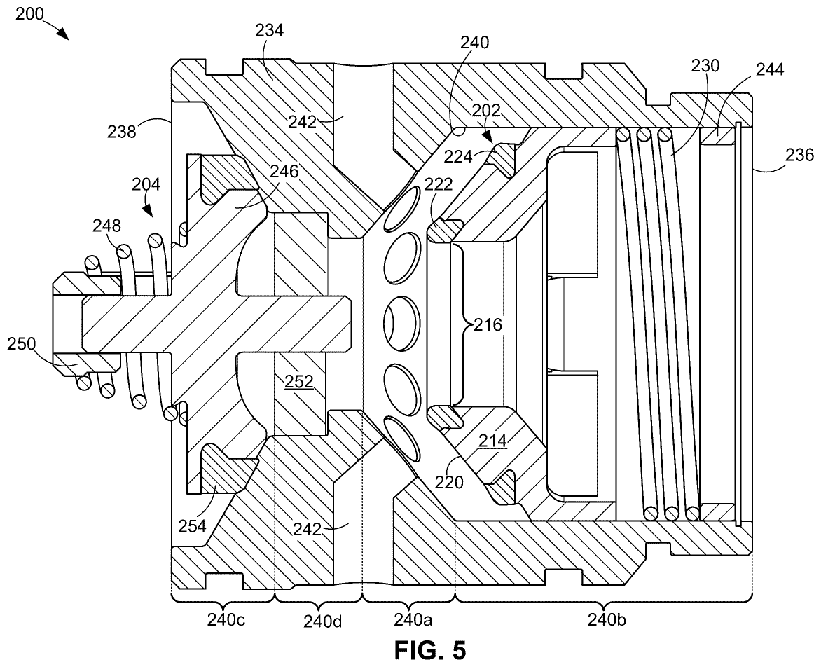

FIG. 3 is a perspective view of an example check valve assembly 212. The check valve assembly 212 may be used in the suction valve assembly 202, as described further in connection with FIGS. 4-5. In some examples, the check valve assembly 212 may be used in the discharge valve assembly 204 or in another valve assembly for a fluid pump or other fluid system.

The check valve assembly 212 may include an annular valve 214 having a central opening 216, a perimeter edge 218, and a sealing surface 220 defined between the central opening 216 and the perimeter edge 218. In some examples, the sealing surface 220 may be sloped inwardly from the perimeter edge 218 to the central opening 216, thereby giving the annular valve 214 the shape of a conical frustum. The check valve assembly 212 may include a first sealing insert 222 embedded in the sealing surface 220 nearer to the central opening 216 than to the perimeter edge 218. For example, the first sealing insert 222 may be embedded in the sealing surface 220 along the central opening 216. The check valve assembly 212 may further include a second sealing insert 224 embedded in the sealing surface 220 nearer to the perimeter edge 218 than to the central opening 216. For example, the second sealing insert 224 may be embedded in the sealing surface 220 along the perimeter edge 218. The first sealing insert 222 and the second sealing insert 224 may be composed of an elastomeric material, such as a urethane, rubber, silicone, latex, or the like. In some implementations, a valve seat associated with the annular valve 214 (such as described in connection with FIGS. 4-5) may include sealing inserts in addition to, or instead of, the annular valve 214.

The check valve assembly 212 may include a base component 226 extending from the perimeter edge 218 of the annular valve 214. For example, the annular valve 214 may sit on the base component 226. The base component 226 may include a set of hoops 228. The hoops 228 may be arranged such that openings of the hoops 228 are concentric with the central opening 216. A hoop 228 furthest from the annular valve 214 may engage with a biasing element 230, of the check valve assembly 212, configured to act on the base component 226, shown and described in connection with FIGS. 4-5. The biasing element 230 may be held by a retainer 244 of the check valve assembly 212, shown and described in connection with FIGS. 4-5. One or more alignment bars 232 may extend between and connect hoops 228 of the set of hoops 228. Thus, the base component 226 may have a frame-like structure that provides minimal flow resistance, and the alignment bars 232 may help to guide and align the check valve assembly 212 (e.g., within the valve cartridge 200).

As indicated above, FIG. 3 is provided as an example. Other examples may differ from what is described with regard to FIG. 3.

FIGS. 4-5 are cross-sectional views of an example of the valve cartridge 200. In FIG. 4, the annular valve 214 of the suction valve assembly 202 is shown in a closed position, while a discharge valve 246 of the discharge valve assembly 204 is shown in an open position. In FIG. 5, the annular valve 214 of the suction valve assembly 202 is shown in an open position, while the discharge valve 246 of the discharge valve assembly 204 is shown in a closed position.

The valve cartridge 200 has a cartridge body 234 having a first end 236 and a second end 238 opposite the first end 236. A fluid cavity 240 is defined in the cartridge body 234. The fluid cavity 240 may extend from the first end 236 to the second end 238 of the cartridge body 234. In some examples, the fluid cavity 240 may define a first sloping region 240a that slopes inwardly with respect to a direction from the first end 236 to the second end 238 of the cartridge body 234 (e.g., the first sloping region 240a may reduce in diameter toward the second end). A straight (e.g., cylindrical) region 240b of the fluid cavity 240 (e.g., having a diameter corresponding to a widest diameter of the first sloping region 240a) may be defined in the fluid cavity 240 between the first end 236 of the cartridge body 234 and the first sloping region 240a. This straight region 240b allows the plunger 120 to project into the fluid cavity 240 during a discharge stroke of the plunger 120.

The fluid cavity 240 may further define a second sloping region 240c that slopes inwardly with respect to a direction from the second end 238 to the first end 236 of the cartridge body 234 (e.g., the second sloping region 240c may reduce in diameter toward the first end). The second sloping region 240c (e.g., at its widest diameter) may form the opening at the second end 238 of the cartridge body 234. A fluid passageway region 240d defined in the fluid cavity 240 may connect the first sloping region 240a and the second sloping region 240c. Accordingly, the fluid cavity 240 may have an overall hourglass-like shape.

One or more (e.g., multiple) suction passageways 242 are defined through the cartridge body 234 and open into the fluid cavity 240. For example, the suction passageway(s) 242 may open into the first sloping region 240a of the fluid cavity 240. Thus, the first sloping region 240a may have openings (e.g., circular openings, oval openings, or another shape openings that promotes flow), leading into the fluid cavity 240, that define ends of the suction passageway(s) 242 (e.g., where the suction passageway(s) 242 have corresponding shapes to the openings). In some implementations, multiple suction passageways 242 may extend radially around the first sloping region 240a (shown in FIG. 5). The suction passageway(s) 242 may fluidly connect the suction chamber 206 of the bore 108 with the fluid cavity 240.

The suction valve assembly 202 is configured to control flow from the suction passageway(s) 242 into the fluid cavity 240. The suction valve assembly 202 may include a biasing element 230 (e.g., one or more springs, one or more elastomeric bands, or the like), held by a retainer 244, configured to bias the annular valve 214 to a closed position (e.g., with respect to the openings in the first sloping region 240a). The sealing surface 220 of the annular valve 214 may be sloped such that the first sloping region 240a and the sealing surface 220 have matching slopes, thereby allowing the annular valve 214 to nest into the first sloping region 240a (e.g., which acts as a valve seat for the annular valve 214). Thus, in the closed position of the annular valve 214, ends of the suction passageway(s) 242 that lead into the fluid cavity 240 are between the first sealing insert 222 and the second sealing insert 224, with the sealing surface 220 covering the ends of the suction passageway(s) 242, thereby sealing the fluid cavity 240 from the suction passageway(s) 242. As described herein, sealing inserts may additionally, or alternatively, be embedded into the cartridge body 234 along the fluid cavity 240 (e.g., at the first sloping region 240a), such that the ends of the suction passageway(s) 242 are between these sealing inserts.

In an open position, the annular valve 214 may allow flow from the suction passageway(s) 242 into the fluid cavity 240 (e.g., the ends of the suction passageway(s) 242 that lead into the fluid cavity 240 are not covered by the sealing surface 220 of the annular valve 214 in the open position). For example, during a suction stroke of the plunger 120, the annular valve 214 may open to allow flow from the suction passageway(s) 242 into the fluid cavity 240.

In a closed position, the annular valve 214 may seal the suction passageway(s) 242 from the fluid cavity 240, as described herein. However, the annular valve 214 may be arranged in the fluid cavity 240 such that the central opening 216 is in a flow path through the fluid cavity 240 in a direction from the first end 236 to the second end 238 of the cartridge body 234. Thus, in the closed position, the annular valve 214 may allow flow through the fluid cavity 240 (e.g., from the first end 236 to the second end 238 of the cartridge body 234) via the central opening 216. For example, during a discharge stroke of the plunger 120, the annular valve 214 may close to seal the suction passageway(s) 242 from the fluid cavity 240 (thereby stopping suction flow), yet also allow flow through the fluid cavity 240 via the central opening 216 (thereby allowing discharge flow).

Moreover, during the discharge stroke of the plunger 120, the discharge valve 246 of the discharge valve assembly 204 may open, such that the flow through the fluid cavity 240 via the central opening 216 is discharged through the open discharge valve 246. The discharge valve assembly 204 may include the discharge valve 246, a biasing element 248 (e.g., one or more springs, one or more elastomeric bands, or the like), held by a retainer 250, configured to bias the discharge valve 246 to a closed position. For example, the discharge valve 246 may close against the second sloping region 240c (e.g., which acts as a valve seat for the discharge valve 246) to seal the fluid passageway region 240d of the fluid cavity 240. The discharge valve assembly 204 may further include a valve guide 252 to maintain proper orientation of the discharge valve 246. In some implementations, the discharge valve 246 may include a sealing insert 254 (e.g., an elastomeric sealing insert) that extends circumferentially around the discharge valve 246 and improves a seal between the discharge valve 246 and the second sloping region 240c of the fluid cavity 240. In some implementations, the first sloping region 240a and/or the second sloping region 240c may include valve strike inserts (e.g., composed of an elastomeric material or a hardened material) that are configured to better withstand the impacts from the valve closings against the cartridge body 234.

In some implementations, the discharge valve assembly 204 may include the annular valve 214. Here, the shape of the fluid cavity 240 and/or the orientation of the suction and discharge valves may be modified from what is shown in FIGS. 4-5 to accommodate use of the annular valve 214 in the discharge valve assembly 204. The cartridge body 234 may define one or more discharge passageways that open into the fluid cavity 240. The annular valve 214 may be biased to a closed position with respect to the discharge passageway(s). In an open position, the annular valve 214 may allow flow from the fluid cavity 240 into the discharge passageway(s) (e.g., the ends of the discharge passageway(s) that lead from the fluid cavity 240 are not covered by the sealing surface 220 of the annular valve 214 in the open position). For example, during a discharge stroke of the plunger 120, the annular valve 214 may open to allow flow from the fluid cavity 240 into the discharge passageway(s). In a closed position, the annular valve 214 may seal the discharge passageway(s) 242 from the fluid cavity 240. However, the annular valve 214 may be arranged in the fluid cavity 240 such that the central opening 216 is in a flow path through the fluid cavity 240. Thus, in the closed position, the annular valve 214 may allow flow through the fluid cavity 240 via the central opening 216. For example, during a suction stroke of the plunger 120, the annular valve 214 may close to seal the discharge passageway(s) from the fluid cavity 240 (thereby stopping discharge flow), yet also allow flow through the fluid cavity 240 via the central opening 216 and through an open suction valve (thereby allowing suction flow).

As indicated above, FIGS. 4-5 are provided as examples. Other examples may differ from what is described with regard to FIGS. 4-5.

### INDUSTRIAL APPLICABILITY

The valve cartridge 200 described herein may be used with any positive displacement fluid pump (e.g., a reciprocating positive displacement fluid pump). For example, a fluid pump, such as a hydraulic fracturing pump, having a power end and a fluid end may use the valve cartridge, described herein, in the fluid end. As described herein, a valve assembly of a fluid pump may include various components, such as a valve, a valve seat, a spring, a spring retainer, or the like, and each of these components are subject to wear and/or failure. Generally, for servicing, the valve assembly may be disassembled and removed from the fluid pump, sometimes using specialized equipment, and then reassembled in the fluid pump following servicing. Accordingly, servicing a valve assembly of the fluid pump can be time consuming and inefficient.

The valve cartridge 200 described herein may include both a suction valve assembly 202 and a discharge valve assembly 204 in a unitary part. In particular, the valve cartridge 200 may be inserted into, or removed from, a bore of a fluid pump as a unit. When the valve cartridge 200 is inserted into the fluid pump, the suction valve assembly 202 and the discharge valve assembly 204 are appropriately positioned to provide control over low-pressure fluid entering the fluid pump and high-pressure fluid exiting the fluid pump. Thus, the valve cartridge 200 facilitates plug-and-play installation of the suction valve assembly 202 and the discharge valve assembly 204 in the fluid pump. After a useful life of the suction valve assembly 202 and the discharge valve assembly 204, the valve cartridge 200 may be removed from the fluid pump and replaced with a new valve cartridge 200. Accordingly, the valve cartridge 200 enables fast and efficient servicing of the suction valve assembly 202 and the discharge valve assembly 204.

Moreover, the suction valve assembly 202 includes an annular valve 214 having a central opening 216. The design of the annular valve 214 facilitates a suction flow path that enters from an outer diameter of the valve cartridge 200, and a discharge flow path through the inner diameter of the valve cartridge 200 through the central opening 216. This configuration facilitates simplification of the fluid end block 103 as well as the suction valve assembly 202.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A valve cartridge for a fluid pump, comprising:
a cartridge body having a first end and a second end opposite the first end;
a fluid cavity defined in the cartridge body;
one or more suction passageways, defined through the cartridge body, that open into the fluid cavity; and
a suction valve assembly configured to control flow from the one or more suction passageways into the fluid cavity, wherein the suction valve assembly comprises:
an annular valve having a central opening, a perimeter edge, and a sealing surface defined between the central opening and the perimeter edge; and
a biasing element configured to bias the annular valve to a closed position,
wherein, in an open position, the annular valve is to allow flow from the one or more suction passageways into the fluid cavity, and
wherein, in the closed position, the annular valve is to seal the one or more suction passageways from the fluid cavity, and to allow flow through the fluid cavity via the central opening.

2. The valve cartridge of claim 1, wherein the annular valve, in the closed position, is to allow flow through the fluid cavity, from the first end to the second end of the cartridge body, via the central opening.

3. The valve cartridge of claim 1, wherein the fluid cavity defines a sloping region that slopes inwardly with respect to a direction from the first end to the second end of the cartridge body, and
wherein the one or more suction passageways open into the sloping region of the fluid cavity.

4. The valve cartridge of claim 3, wherein the sealing surface of the annular valve is sloped inwardly from the perimeter edge to the central opening such that the sloping region and the sealing surface have matching slopes.

5. The valve cartridge of claim 3, wherein the sloping region is a first sloping region and the fluid cavity further defines a second sloping region that slopes inwardly with respect to a direction from the second end to the first end of the cartridge body, and
wherein a fluid passageway region defined in the fluid cavity connects the first sloping region and the second sloping region.

6. The valve cartridge of claim 5, further comprising:
a discharge valve assembly configured to control flow from the fluid passageway region into the second sloping region.

7. The valve cartridge of claim 1, wherein the suction valve assembly further comprises:
a first sealing insert embedded in the sealing surface nearer to the central opening than to the perimeter edge; and
a second sealing insert embedded in the sealing surface nearer to the perimeter edge than to the central opening.

8. The valve cartridge of claim 7, wherein, in the closed position of the annular valve, ends of the one or more suction passageways that lead into the fluid cavity are between the first sealing insert and the second sealing insert.

9. The valve cartridge of claim 1, wherein the fluid cavity extends through the cartridge body from the first end to the second end of the cartridge body.

10. A check valve assembly, comprising:
an annular valve having a central opening, a perimeter edge, and a sealing surface defined between the central opening and the perimeter edge;
a first sealing insert embedded in the annular valve nearer to the central opening than to the perimeter edge; and
a second sealing insert embedded in the annular valve nearer to the perimeter edge than to the central opening.

11. The check valve assembly of claim 10, wherein the sealing surface is sloped inwardly from the perimeter edge to the central opening.

12. The check valve assembly of claim 10, wherein the annular valve is in a shape of a conical frustum.

13. The check valve assembly of claim 10, further comprising:
a base component extending from the perimeter edge of the annular valve.

14. The check valve assembly of claim 13, wherein the base component comprises:
a set of hoops concentric with the central opening; and
one or more alignment bars that extend between hoops of the set of hoops.

15. The check valve assembly of claim 13, further comprising:
a biasing element configured to act on the base component.

16. A fluid pump, comprising:
a fluid end having a fluid end block with a bore, and a plunger configured to reciprocate with respect to the bore;
a power end operably connected to the plunger; and
a valve cartridge, configured for insertion into and removal from the bore as a unit, comprising:
a cartridge body having a first end and a second end opposite the first end;
a fluid cavity defined in the cartridge body;
one or more passageways, defined through the cartridge body, that open into the fluid cavity; and
a valve assembly configured to control flow between the one or more passageways and the fluid cavity, wherein the valve assembly comprises:
an annular valve having a central opening, a perimeter edge, and a sealing surface defined between the central opening and the perimeter edge; and
a biasing element configured to bias the annular valve to a closed position.

17. The fluid pump of claim 16, wherein the annular valve is to open during a suction stroke of the plunger to allow flow from the one or more passageways into the fluid cavity, and
wherein the annular valve is to close during a discharge stroke of the plunger to seal the one or more passageways from the fluid cavity, and to allow flow through the fluid cavity via the central opening and through an open discharge valve of the valve cartridge.

18. The fluid pump of claim 16, wherein the annular valve is to close during a suction stroke of the plunger to seal the one or more passageways from the fluid cavity, and to allow flow through the fluid cavity via the central opening and through an open suction valve of the valve cartridge, and
wherein the annular valve is to open during a discharge stroke of the plunger to allow flow from the fluid cavity into the one or more passageways.

19. The fluid pump of claim 16, wherein the central opening is in a flow path through the fluid cavity in a direction from the first end to the second end of the cartridge body.

20. The fluid pump of claim 16, wherein the fluid cavity defines a sloping region that slopes inwardly with respect to a direction from the first end to the second end of the cartridge body,
wherein the one or more passageways open into the sloping region of the fluid cavity, and
wherein the sealing surface of the annular valve is sloped inwardly from the perimeter edge to the central opening such that the sloping region and the sealing surface have matching slopes.
